(19) United States
(12) Patent Application Publication
(10) Pub. No.: US 2019/0049380 A1
(43) Pub. Date: Feb. 14, 2019

(54) PROTECTIVE DEVICE FOR AN OPTOCHEMICAL SENSOR, AND CORRESPONDING OPTOCHEMICAL SENSOR

(71) Applicant: Endress+Hauser Conducta GmbH+Co. KG, Gerlingen (DE)

(72) Inventor: Andreas Löbbert, Waldheim (DE)

(21) Appl. No.: 16/103,687

(22) Filed: Aug. 14, 2018

(30) Foreign Application Priority Data
Aug. 14, 2017 (DE) 10 2017 118 504.6

(51) Int. Cl. G01N 21/64

(52) U.S. Cl. CPC G01N 21/6428; G01N 2021/6432

(57) ABSTRACT

The present disclosure relates to a protective device for a sensor unit of an optochemical sensor for determining or monitoring at least one analyte present in a medium, including at least one protective substance for protecting the sensor unit against a physical and/or chemical alteration caused by at least one substance contained in the medium, and an at least partially media-permeable functional layer, where the protective device, in a region facing towards the medium, can be attached to the sensor unit or applied to the sensor unit. The present disclosure further relates to an optochemical sensor having a protective device according to the present disclosure.

### CROSS-REFERENCE TO RELATED APPLICATION

The present application is related to and claims the priority benefit of German Patent Application No. 10 2017 118 504.6, filed on Aug. 14, 2017, the entire contents of which are incorporated herein by reference.

### TECHNICAL FIELD

The present disclosure relates to a protective device for an optochemical sensor for determining and/or monitoring at least one analyte present in a medium, as well as an electrochemical sensor equipped with the protective device according to the present disclosure.

### BACKGROUND

An optochemical analyte sensor, e.g., an oxygen sensor, is based upon the principle of analyte-induced fluorescence quenching or luminescence quenching of an indicator, for example, of an organic dye matched to a predetermined analyte, which is typically introduced into a polymer matrix. The sensor unit of such a sensor comprises, in particular, a substrate, e.g., a small glass plate or an optical fiber, to which the polymer/dye mixture matched to a predetermined analyte is applied as a solid film. The respective underlying measurement principles are known from a multitude of publications. Corresponding sensors are produced and marketed by the applicant in the most varied embodiments.

A device was disclosed in WO 2005/100957 A1 for determining and/or monitoring an analyte contained in a fluid process medium. The known device has a sensor unit with a measuring membrane which possesses a porous support structure. Embedded into the support structure is an indicator in the form of a luminescent substance that comes into contact with the process medium. Furthermore, a transmitting unit and a receiving unit are provided, wherein the transmitting unit transmits measuring radiation and excites the indicator to emit luminescence radiation, and wherein the receiving unit detects the correspondingly generated luminescence radiation. Using the quenching of the luminescence radiation of the indicator, a control/evaluation unit determines the concentration or the partial pressure/pressure of the analyte in the process medium. Luminescence is incidentally the generic term for the generation of optical radiation in a substance that occurs with the transition from an excited state to the basic state.

In continuous operation of an optochemical sensor, a fading and/or washing out of the respective indicator from the sensor unit may occur, which leads to a distinct reduction in the photophysical properties of the sensor. Namely, the sensor unit of a generic sensor offers no sufficient protection of the indicators located therein from deterioration, for example, due to reactive compounds from the medium to be analyzed. In particular, the hydrolysis stability of the respective sensor unit with respect to strong acids and alkaline solutions is problematic, such as after longer contact, as well as regular changes of media, for instance, those that involve comparably large temperature gradients. Moreover, a mechanical aging of the sensor unit may occur, up to the point of a cracking and detachment of the sensor unit, in particular, in the form of a membrane. The result is, possibly, a severe adulteration of the respective determined measurement values. Corresponding sensor units, also referred to as sensor spots, moreover exhibit a change in the phase angle, in particular, at low partial pressures, after treatment with common cleaning agents and with gamma radiation.

To protect the sensor unit from the problems described above, it is known to add to the sensor unit various substances which are to prevent the aging of the polymer matrix and of the dyes, for example, due to photo-oxidation, in continuing measurement operation. The sensor units typically contain additives of different radical scavengers, for example, diazabicyclo[2.2.2]octane (DABCO). From the article, “Singlet Oxygen-Induced Photodegradation of the Polymers and Dyes in Optical Sensing Materials and the Effect of Stabilizers on these Processes,” by Barbara Enco et al. in the Journal of Physical Chemistry A 2013, 2017, 8873-8882, it has also been known to add the amine 1,4-diazabicyclo[2.2.2]octane (DABCO) to the sensor unit. 1,4-diazabicyclo[2.2.2]octane to be added. It is thereby a protective substance which is applied in polymers, in particular, to protect against aging. However, 1,4-diazabicyclo[2.2.2]octane has the disadvantage of a comparably good water solubility, which does not ensure a durable protection.

By contrast, EP0907074B1 discloses the addition of amines, in particular, what are known as Hindered Amine Light Stabilizers (HALS), to a sensor unit of an optochemical sensor in order to reduce a photo-oxidative aging of the polymer matrix and the dye via the presence of singlet oxygen in the region of the sensor unit. These are, advantageously, water-insoluble protective substances.

However, both types of protective substances are suitable only to a limited extent, since the substances may cause cross-sensitivities in the sensor unit, in particular, reactions with the dye after migration, in particular, if the protective substances likewise quench. From EP102012111686A1, protectors consisting of catalysts, for example, heavy metal oxides, metals, or reducing agents, are thus to be added to the sensor unit, which protectors are integrated directly into the sensor spot, which is typically present in the form of a layer structure. This advantageously leads to a reduction in dye aging, for example, by disinfecting agents. However, for one thing, a reserve of the protectors that is present in the sensor unit is exhausted relatively quickly due to the typically low thickness of the sensor unit, and thus has only a limited useful life. Moreover, various substances which may typically be contained in the environment of the sensor unit may easily poison the catalysts, and thus make them ineffective. In this regard, from the application note, “Increasing LDO Longevity in Brewing—Maximizing Optical Sensor Life in Brewing Processes, 2015,” by the Hach company (www.hach.com; article available at: https://www.hach.com/asset-get.download.jsa?id=51280962693), various measures have been proposed for protecting against a premature aging of the indicator of an optochemical sensor via a suitable adaptation of the respective environmental conditions, for example:
an interruption of the measurement operation above predeterminable temperatures
an interruption of the measurement operation during cleaning-in-place (CIP)
extension of the measurement intervals if CIP cycles occur more often
optimization of the installation position of the sensor, e.g., with regard to a distance from an inlet for disinfecting agent
avoidance of an installation of the sensor in proximity to UV lamps

Although such measures are helpful, they are normally not sufficient for strong, continuous loads, as they are necessary for cleaning in, for example, the foodstuffs industry.

### SUMMARY

The present disclosure is thus based upon the aim of providing a possibility of sustainably avoiding premature aging of a sensor unit of an optochemical sensor. This aim is achieved by the protective device and the optochemical sensor according to the present disclosure.

With regard to the protective device, the aim is achieved by a protective device for a sensor unit of an optochemical sensor for determining and/or monitoring at least one analyte present in a medium, comprising at least one protective substance for protecting the sensor unit from a physical and/or chemical alteration caused by at least one substance contained in the medium, and a functional layer that is at least partially permeable to medium, wherein the protective device, in a region facing towards the medium, can be attached to the sensor unit or can be applied to the sensor unit.

The protective device can, in particular, be attached to the sensor unit or can be applied to the sensor unit so as to be releasable. The protective device ensures that the sensor unit does not come into direct contact with the medium. It is arranged between the sensor unit and the medium.

According to the present disclosure, the protective substances are thus not directly integrated into the sensor unit; rather, they are provided by means of a separate protective device. Various advantages result from this. The protective device may be individually adapted to various applications of the respective sensor. The protective device may be exchanged upon changing the application. Similarly, an exchange may take place if the protective substance is consumed in the continuing operation, the protective substances become ineffective, or damage is present in the region of the protective device. The respective sensor may thereby continue to be used without restriction. Moreover, a spatial separation of the sensor unit from the protective substances provides that cross-sensitivities in the region of the sensor unit—in particular, due to migrations of the indicators and the respective protective substance, and the occurrence of chemical reactions—lead to an unwanted chemical alteration of the sensor unit—in particular, of the polymer matrix.

The protective device according to the present disclosure thus advantageously prevents premature aging of the sensor unit. The possible embodiments of the present disclosure that are described in the following can be arbitrarily combined with one another. It is likewise noted that the present disclosure is in no way limited to the following examples.

The protective substance is preferably a substance which binds to reactive—in particular, diffusion-capable—substances which are present in the medium or in the environment of the sensor, or which may convert them into less reactive substances—in particular, by means of chemisorption, physisorption, or catalysis.

It is advantageous if the at least one protective substance is a buffer—in particular, a pH buffer polymer, a pH buffer solution, a redox buffer, a redox buffer polymer; an adsorbent; a radical scavenger; a reducing agent; a catalyst; or a polymer—in particular, an acrylamide—an acrylamide with at least one imidazole unit.

With regard to the functional layer, it is advantageous if the functional layer is embodied in the form of a diaphragm—in particular, a ceramic diaphragm, a fiber diaphragm, or a ground diaphragm; in the form of an annular gap; in the form of an—in particular, organic or inorganic—membrane; in the form of a gel; or in the form of a dispersion. It may be a fluid transformation, wherein all fluid transformations known to the person skilled in the art from the field of pH electrode technology are considered, for example.

It is to be noted that the selection of functional layer and protective substance should each take place with consideration of the concrete application and corresponding to the respective resulting requirements.

One embodiment of the protective device according to the present disclosure includes that the protective device be designed in the form of a cap or capsule which can be connected with the sensor unit—in particular, so as to be releasable. For example, the protective device may be pulled over or placed on the sensor unit.

A further embodiment includes that the protective device comprise an attachment unit for attachment of the protective device to the sensor—in particular, so as to be releasable. For example, the protective device may be designed like a sleeve, at least in segments, and the attachment take place by means of a welding, soldering, bolting, or gluing, for example.

Another embodiment of the protective device includes that the protective substance be introduced into the functional layer. Alternatively, however, the protective substance may also be contained in a protective layer which is applied to a side of the functional layer that faces away from the medium. In this instance, the protective device is, in particular, a layer structure comprising at least two layers. It is likewise conceivable that the protective substance be part of an—in particular, aqueous—solution which is at least partially surrounded by the at least one functional layer.

An additional embodiment of the protective device includes that the protective device can be attached to the sensor unit such that a region of said protective device that faces towards the medium and/or a transition region between the protective device and the sensor unit are essentially gapless and/or without clearance, and/or wherein a surface of the protective device that faces towards the medium has a surface region shaped so as to optimize flow.

As a result of the gapless sealing between the sensor and the protective device, common hygiene regulations, e.g., as they are stipulated in the foodstuffs industry, may be complied with. In the context of the present disclosure, “gapless” means, in particular, that voids in which deposits may adhere, which deposits may be removed by cleaning processes that are typical in process and/or automation engineering, cannot form in connection regions of various components with medium contact.

With a use of a corresponding sensor in a pipeline, bubbles may also form on the surface of the protective device that faces towards the medium, which may, disadvantageously, lead to an adulteration of the measurement values. This may be prevented by an embodiment according to the present disclosure of the surface facing towards the medium, which surface has a bubble-repelling geometry.

In conjunction with the fulfillment of hygiene regulations of the protective device or of the respective sensor, and in conjunction with the bubble-repelling surface geometry, reference is made, in particular, to U.S. Patent Application US2017184499A1, which is also incorporated by reference in its entirety into the scope of the present application. The bubble-repelling geometries of the sensor cap that are disclosed there can, mutatis mutandis, also be applied to the protective device according to the present disclosure.

An additional embodiment includes that the protective device comprise at least two functional layers, wherein at least the protective substance is located between the first functional layer and the second functional layer. For example, an additional layer comprising a suitable filler material is located between the two functional layers. One possibility consists in the integration of—in particular, inorganic—fibers which ensure a quick water absorption due to capillary forces. Alternatively or additionally, a polymer or a gel may also be integrated, e.g., a polymer or gel which prevents the uptake of bubbles into the protective device.

A further embodiment of the present disclosure includes that the protective substance be introduced into an inlay which is at least partially surrounded by the at least one functional layer. For example, the inlay may be designed and arranged such that it is destroyed in the event of the attachment or application of the protective device to or on the sensor unit, and in this way releases at least the protective substance.

An additional embodiment includes that the protective device have at least one diffusion-inhibiting component permeable to analyte. The inhibition of the diffusion may thereby take place, on the one hand, in that specific substances cannot pass the diffusion-inhibiting component. However, it is likewise conceivable, on the other hand, that the diffusion-inhibiting component be such that it binds corresponding substances or converts them into less reactive substances which are then bound. The diffusion-inhibiting component may, on the one hand, be arranged together with the protective substance. For example, the at least one functional layer may be at least partially comprised of the diffusion-inhibiting component. The protective substance may likewise be introduced into the functional layer. It is likewise conceivable that the protective substance and/or the diffusion-inhibiting component be part of an—in particular, aqueous—solution which is at least partially surrounded by the at least one functional layer.

A further embodiment includes that the diffusion-inhibiting component be contained in a diffusion barrier layer, which diffusion barrier layer is arranged on a side of the protective device that faces towards the sensor unit. In this way, the diffusion-inhibiting component prevents the penetration of the protective substance, as well as of additional substances present in the environment of the sensor, into the sensor unit.

An additional embodiment of the protective device according to the present disclosure includes that the protective device comprise at least one indicator component which is designed to indicate a need to exchange the protective device. The indicator component is preferably a color indicator—in particular, a dye or a fluorescent dye—which is introduced into the functional layer, for example. Alternatively, it may also be part of an—in particular, aqueous—solution or may be contained in the protective layer or diffusion barrier layer.

The color indicator preferably varies in proportion to the state of the sensor unit. Depending upon the indicator component that is used, different evaluation methods that are well-known to the person skilled in the art are to be considered for determining the discoloration, e.g., by means of adsorption phosphorescence emission or adsorption reflection measurement. However, also the use of at least one reference sensor or of a dye which induces a signal upon exceeding a predeterminable measurement value deviation, which signal signals the need to exchange the protective device.

An indicator component may be arranged both at the sensor side and at the media side, and thus both in the region of the protective device and in the region of the sensor unit of the sensor. It is likewise conceivable that the protective device be comprised at least partially of a translucent or transparent material so that a change in the region of the indicator component can be visually detected.

It is also advantageous if the protective device comprises a substance for reducing a surface tension of at least one component of the protective device—in particular, an alcohol or surfactant.

It is likewise advantageous if the protective device has at least one solid (in particular, an—in particular, inorganic—fiber) for uptake of fluid. Moreover, a component—in particular, a polymer or gel—may be provided to avoid the formation of gas bubbles in the region of the protective device.

The aim forming the basis of the present disclosure is further achieved via an optochemical sensor for determining and/or monitoring at least one analyte present in a medium, with a sensor unit, on which a protective device according to at least one of the described embodiments is arranged; an electronics unit; a light source; and a detection unit.

The sensor unit has an optical component which is comprised at least in part of a material that is transparent to measuring radiation, wherein a matrix—in particular, a polymer matrix—that has at least one analyte-sensitive functional layer is arranged on the optical component. The sensor unit is thereby typically part of a sensor cap, which typically can either be connected to a sensor shaft of the sensor so as to be releasable or which is designed as an integral component of the sensor.

The analytes to be determined or monitored are arbitrary substances that are present in the medium—for example, ions, such as calcium, nitrate, lactate; gases, e.g., oxygen, chlorine, carbon dioxide, or ammonium, etc.; or even glucose, lactose, fructose, or urea. In several embodiments of the present disclosure, the matrix, or at least one of the functional layers of the matrix, can be arranged in or on a substrate film consisting of plastic or a metal mesh. This combination of matrix with at least one functional layer and carrier medium yields a membrane in the sense of the present disclosure.

The matrix may also be a multi-layer system that consists of at least two functional layers, wherein one of the functional layers contains or consists of the analyte-sensitive substance. Known sensors often even have at least three functional layers, e.g., a first functional layer that is selectively permeable to the analyte; a second functional layer for chemical and/or mechanical stability; and a third functional layer that contains the analyte-sensitive and thus sensor-specific substance. When correspondingly excited by a light source, this third functional layer emits a luminescence or fluorescence or phosphorescence signal at a specific wavelength and/or an analyte concentration-specific phase angle, or it absorbs specific wavelengths of the radiated light. The corresponding change in the measuring radiation is detected and is a measure of the concentration of the analyte in the media.

For example, the optical component is designed such that it allows at least one defined wavelength of light to pass, whereas wavelengths outside of the defined wavelength are filtered out. For this purpose, one of the functional layers of the membrane or matrix is designed as a layer with a filtering function. The light source and detector unit are arranged immediately at the region of the optical component facing away from the medium. The measuring radiation or light is radiated directly toward the optical component, or the detector unit receives the light directly from the optical component. In this context, “direct” means without an intermediate optical waveguide. Alternatively, however, the optochemical sensor may also comprise at least one optical waveguide by means of which the light is guided from the light source to the region of the optical component facing away from the medium, and from the region of the optical component facing away from the medium to the detector unit. The optical waveguide may be designed as a dimensionally-stable, rod-shaped component on whose end region facing towards the medium the optical components is formed. The optical waveguide and optical component accordingly form an integral unit.

Preferably, the optical component consists of a solid such as glass. In some of the embodiments described in this application, the optical component can, however, be made from at least one elastic material. Furthermore, the optical component can be constructed from a solid material and an elastic material. Depending upon the sensor design, the region of the optical component that is in contact with the sleeve-shaped component, for example, consists of an elastic material, whereas the rest is made of a solid.

It is to be noted that the embodiments described in connection with the protective device according to the present disclosure can also be applied, mutatis mutandis, to the optochemical sensor according to the present disclosure, and vice versa.

### BRIEF DESCRIPTION OF THE DRAWINGS

The present disclosure is explained in greater detail with reference to the following figures. Shown are:

FIG. 1A is a longitudinal section of a sensor cap known from the prior art;

FIG. 1B is a detail view of the sensor cap of FIG. 1A;

FIGS. 2A-2C show various embodiments of a protective device according to the present disclosure in the form of a layer structure;

FIGS. 3A-3D show various embodiments of the protective device according to the present disclosure, with a functional layer;

FIGS. 4A-4M show various embodiments of the protective device according to the present disclosure, with two functional layers; and

FIGS. 5A-5C show an embodiment of the protective device according to the present disclosure, in which the protective substance is introduced into an inlay.

In the description, identical elements are provided with the same reference characters.

### DETAILED DESCRIPTION

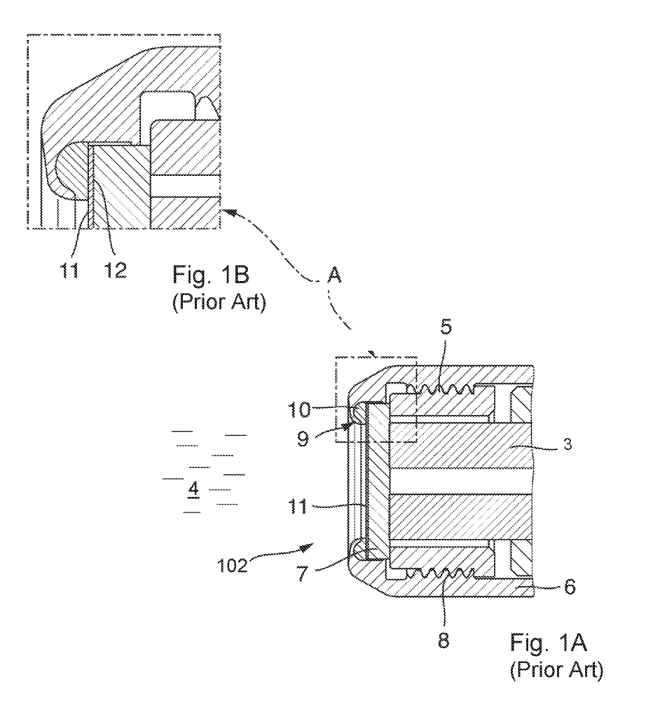

FIGS. 1A and 1B show a longitudinal section through an optochemical sensor cap 102, known from the prior art, of an optochemical sensor 1 (not shown). The sensor cap 102 consists of a cylindrical housing, frequently also termed a spot housing, that consists of a sleeve-shaped outer component 6 and a plug-in component 5. The components 5, 6, 7 are connected to each other in a region of the sensor shaft by means a threaded joint 8.

The sensor cap 102 seals an end region of the cylindrical housing facing towards the medium 4 and comprises a matrix 11 for determining the analyte. The analytes to be determined or monitored are any ions or gases that are present in the medium 4. The analyte-sensitive matrix 11 may consist of several functional layers. One of the functional layers 12 contains the analyte-sensitive substance.

In the known solution, a round, flat, transparent glass substrate, on whose surface facing the medium 4 the analyte-sensitive matrix 11 is applied, is used as an optical component 7 or optical element. The end region of the sleeve-shaped outer component 6, said end region facing towards the medium 4, has an annular recess 9 into which an O-ring 10 is inserted as a seal. By means of the O-ring 10, the sleeve-shaped outer component 6 in the connecting region 10 is sealed axially and gap-free against the analyte-sensitive matrix 11 or membrane.

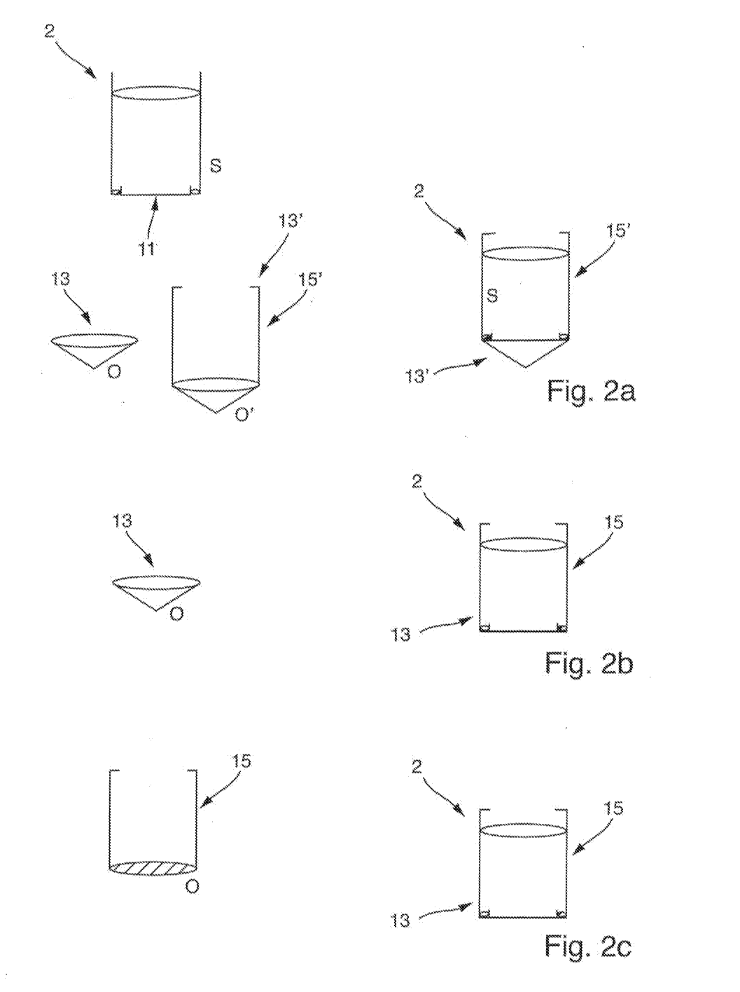

A protective device 13 according to the present disclosure, as presented by way of example in different embodiments in FIGS. 2, 3 and FIG. 4, serves to protect the sensor unit 3, in particular, the matrix 11, against premature aging.

Depending upon the application, the protective device 13 may have a different design in the event that a protection against aggressive substances in typical disinfectants is sought, for example, as they occur in the foodstuffs industry. Typical disinfectants which the capsule according to the present disclosure is to protect against are ozone, hypobromides which contain free bromine, hypochlorites which contain free chlorine, hydrogen peroxide, peracetic acid, or also chlorine dioxide. In many instances, a basic buffering in combination with reducing materials or radical scavengers and/or absorbers is, for example, suitable for rendering the respective disinfectant ineffective. The disinfectant contains ozone, but acid buffers are also conceivable, since—for example, given ozone—the half-time of exchange is starkly increased, and thus un-decomposed ozone may react with reducing agents or absorbers. However, acid buffers are unsuitable for chlorinated disinfectants.

The following possible reactions, which may proceed within the protective device 13 in order to render the disinfectant ineffective, are indicated by way of example for chlorine and ozone:

Chlorine:

Cl₂+2OH⁻->Cl⁻+OCl⁻+H₂O

Ozone:

1 O₃+OH^{—}→HO₂^{—}+O₂

2 O₃+HO₂^{—}→⁻OH+O₂⁻+O₂

Depending upon the desired usage, the protective substance may, for example, be a buffer—in particular, a pH buffer polymer, a pH buffer solution, a redox buffer, a redox buffer polymer; an adsorbent; a radical scavenger; a reducing agent; a catalyst; or a polymer—in particular, an acrylamide, such as an acrylamide with at least one imidazole unit. A listing of a few examples of suitable protective substances is given in the following. However, it is to be noted that this list is in no way exhaustive.

pH Buffer:
inorganic and organic buffers from the range of carbonate buffers, phosphate buffers, borate buffers, or phthalates,
buffers which contain trisodium citrate, magnesium citrate, sodium lactate, sodium acetate, potassium acetate, sodium tetraborate, potassium or sodium tartrate, sodium carbonate, potassium carbonate, sodium hydrogen carbonate, ammonium malate, disodium malate, monosodium malate, monopotassium malate, alkali monophosphates, potassium/sodium/lithium salt, calcium monohydrogen phosphate, magnesium monohydrogen phosphate, or mixtures of at least two of the cited substances,
buffers in which the primary and/or side chain polymer has with an imidazole unit, e.g., a polyacrylamide copolymer with imidazoles which form low-viscosity gels,
Nafion,
silicones with buffering groups such as imidazole, or
exines

Redox Buffer:
inorganic substances,
polymers with redox properties, such as ferrocene units, metalloporphyrin units, metallophthalocyanin units, or
polymers with quinoid units

Absorbents:
graphite,
carbon nanotubes,
activated charcoal,
graphenes/graphene oxide, carbon nanotubes (CNT), and derivatives,
zeolites,
metal organic frameworks (MOF),
zeolitic imidazolate frameworks (ZIF),
high-fiber materials such as polyimides—for example, FDA-DAM,
copolymers consisting of dianhydride 5,5[2,2,2 trifluoromethyl-1-(trifluoromethyl) ethylindene] bis-1,3-isobenzofurandione and diamine 2,4,6-trimethyl 1,3-phenylendiamine, or
an aerosol, or
exines (for example, Lycopodium Clavatum)

Reducing Agent:
unsaturated hydrocarbons,
alkenes,
alkines,
thiols,
disulfides,
substances (for example, polymers or oligomers) with amine or thiol groups,
polymers with amine or thiol groups,
substances with unsaturated alkyl groups, or

Catalyst:
metals such as finely-powdered platinum, gold, or silver, or
subgroup metallic oxides—for example, titanium oxide, silicon oxide, aluminum oxide, zirconium oxides, zeolites, MOF's, or ZIF's

Polymers:
analyte-permeable polymers,
acrylamides,
acrylamides with imidazole units which are preferably attached in the 2,4,5 position,
polymers with sulfonic acid groups—for example, PAMPS,
polymers containing amine,
exines, unmodified or modified—for example, with a pH buffer or a redox buffer unit,
polymers with redox buffer units or pH buffer units

The at least one functional layer may, for example, be embodied in the form of a diaphragm—in particular, a ceramic diaphragm, a fiber diaphragm, or a ground diaphragm; in the form of an annular gap; in the form of an—in particular, organic or inorganic—membrane; in the form of a gel; or in the form of a dispersion.

If the functional layer is a membrane, all analyte-permeable polymers, for example, are thus conceivable for forming the membrane sealed, in particular, at the medium side. Common polymers are often comprised of porous and non-porous tetrafluoroethylene (e.g., Teflon); fluorinated cross-linked and cross-linked primary and side chain polymers; silicones; fluorinated silicones; or combinations of these. Moreover, softeners are optionally used.

The functional layer may be designed to be both water-impermeable and water-permeable. Water-permeable functional layers, in particular, lend themselves to combination with a bubble-repellent surface geometry.

In the event that the protective device has an analyte-permeable, diffusion-inhibiting component, the latter may be: a gel—in particular, a gel having at least one functional group or at least one filler; a polymer—in particular, a polymer blend or a block polymer having at least one hydrophilic and/or hydrophobic unit, an adsorbent (in particular, activated charcoal or graphene oxide), a reducing agent, a catalyst (in particular, a metal oxide), a redox agent; an unsaturated substance; water; or an ionic fluid.

The diffusion-inhibiting component may, for example, be of such a design that it is not permeable to various reactive substances, for example, to free chlorine or ozone. Alternatively, however, the diffusion-inhibiting component may also be such that it binds corresponding substances or also converts them into less-reactive substances. However, the diffusion-inhibiting component is in every instance permeable to the analyte.

For example, the diffusion-inhibiting component may be part of a diffusion barrier layer which has a pH value >7, preferably >8, and in particular preferably >9. For example, at a pH value >9, free chlorine is typically no longer present. The diffusion barrier layer may also act as a buffer layer, for example. However, the diffusion barrier layer may also be composed of different sub-layers having different pH values, which sub-layers are arranged following one another. For example, one sub-layer may be designed as a neutral buffer layer.

Examples of different possible embodiments for a protective device 13 having a first functional layer 14 are shown in FIG. 2. Shown in FIG. 2a are a sensor cap 2 in simplified presentation and two similar embodiments of protective device 13 and 13′, which respectively have a bubble-repelling geometry in a surface region O or O′ facing towards the medium. Shown on the right side is the protective device 13′ in a state attached to the sensor cap 2 containing the sensor unit 3 (not shown). The protective device 13 has a functional layer 14 (not separately designated here) which is provided essentially on the region facing towards the medium 4 and containing the polymer matrix 11, whereas, in the case of the protective device, a cylindrical sleeve 15′ is, moreover, provided which at least partially covers a side wall S of the sensor cap 2 in the installed state on the sensor unit 3.

In the present instance according to FIG. 2a, the surface regions O and O′ of the protective devices 13 or 13′ that face towards the medium 4 are of conical design, and thus have a bubble-repelling geometry. However, this is not mandatory, as, for example, is evident using the protective device 13 from FIG. 2b. As in the case of FIG. 2a, in FIG. 2b, the protective device 13 is depicted, on the left, as a separate unit and, on the right, in the state in which it is installed at the sensor cap 2.

For attachment to the sensor unit 3, the protective devices 13 from FIGS. 2a-2c may, for example, respectively be pulled over the sensor cap 2 or be plugged onto the sensor cap 2. However, numerous other possibilities are also alternatively conceivable which fall under the present disclosure. For example, an attachment unit (not depicted) may be provided for the protective device 13.

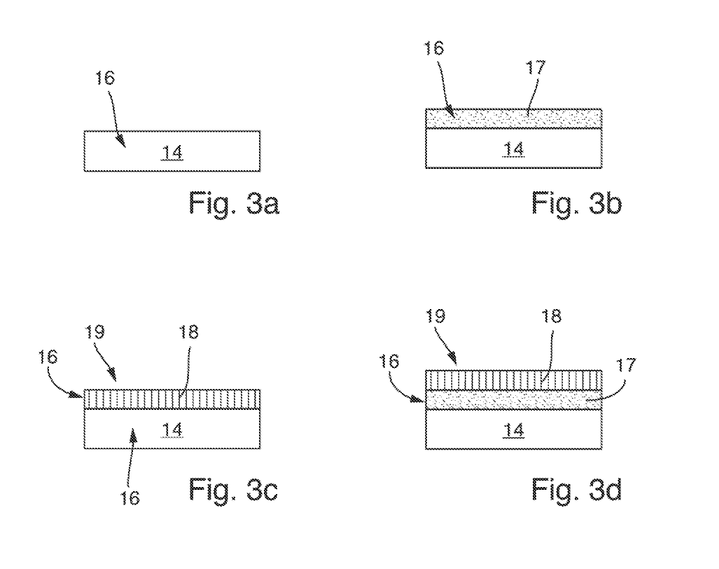

Various possibilities are conceivable for the arrangement of the at least one protective substance 16 within the protective device 13, which possibilities are drawn by way of example in FIGS. 3a-3d, for the case of a protective device 13 with a functional layer 14. The functional layer 14 is depicted as a flat layer without special bubble-repelling geometry in the surface region O facing towards the medium. Other embodiments may, naturally, comprise surface-repelling geometries.

In the instance depicted in FIG. 3a, the protective substance 16 is introduced into the functional layer 14. Alternatively, however, as depicted in FIG. 3b, the protective substance 16 may also be contained in a protective layer 17, which is arranged following the functional layer 14 on a side facing away from the medium 4. Moreover, if the protective device 13 contains a diffusion-inhibiting component 18, this may, on the one hand, be the functional layer 14, or be arranged in a separate diffusion barrier layer 19 which is arranged on the side of the functional layer 14 facing away from the medium 4, into which is, in turn, integrated the protective substance 16, as shown in FIG. 3c. Alternatively, the functional layer 14, a protective layer 16, and a diffusion barrier layer 19 may also be arranged one atop the other, as illustrated in FIG. 3d.

In addition to a layer structure for the protective device 13, as indicated in FIGS. 3b-3d, many additional possibilities are still conceivable which, altogether, fall under the present disclosure. For example, the protective substance and/or the diffusion-inhibiting component may also be part of a solution, for example, an aqueous solution, which is at least partially surrounded by the at least one functional layer 14.

In the event that the functional layer 14, the protective layer 16, and/or the diffusion barrier layer 19 is or are comprised of a gel, the protective device 13 may also be attached to the sensor unit 3 by means of a covalent bond. In this regard, a protective device 13 is preferably in the form of a gel layer sequence with various pH buffer gels. A pH-neutral gel (pH 5-9) is arranged facing towards the sensor unit 3 and serves as a diffusion barrier layer 19. Following this, and thus facing towards the medium 4, is at least one additional gel layer serving as a protective layer 16, e.g., with a pH buffering in the acid or alkaline pH range (pH<5 or pH>9). However, multiple gel layers with different pH bufferings, for example, graduated pH bufferings, serving as a protective layer 16, are also conceivable.

A preferred embodiment for a protective device 13 includes that the diffusion-inhibiting component 18 be a neutral gel, for example, the gel indicated in the following structural formula:

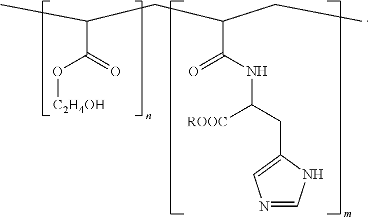

It is, in this case, a neutral gel in the form of an acrylamide with imidazole units at the 2, 4, and 5 positions. This neutral gel is preferably combined with a protective substance in the form of an acid gel, e.g., the poly(2-acrylamide-2-metyl-propane sulfonic acid) and polyacrylamide, PAMPS-PDAAAm, indicated in the following structural formula:

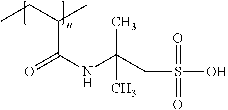

By contrast, if a basic protective substance 16 is desired, a polyamine, polyacrylamide with a pyridine unit, or tertiary and quaternary amine units, an ammonium compound such as diallyldimethylammonium chloride (DADMAC), or also a, for example modified, cellulose, an exine, or a polystyrene with a diethylaminoethyl group may be used. A preferred example of a modified cellulose is given in the following structural form:

The neutral gel and the acid or base gel are thereby preferably arranged in successive layers, similarly as in FIG. 3d.

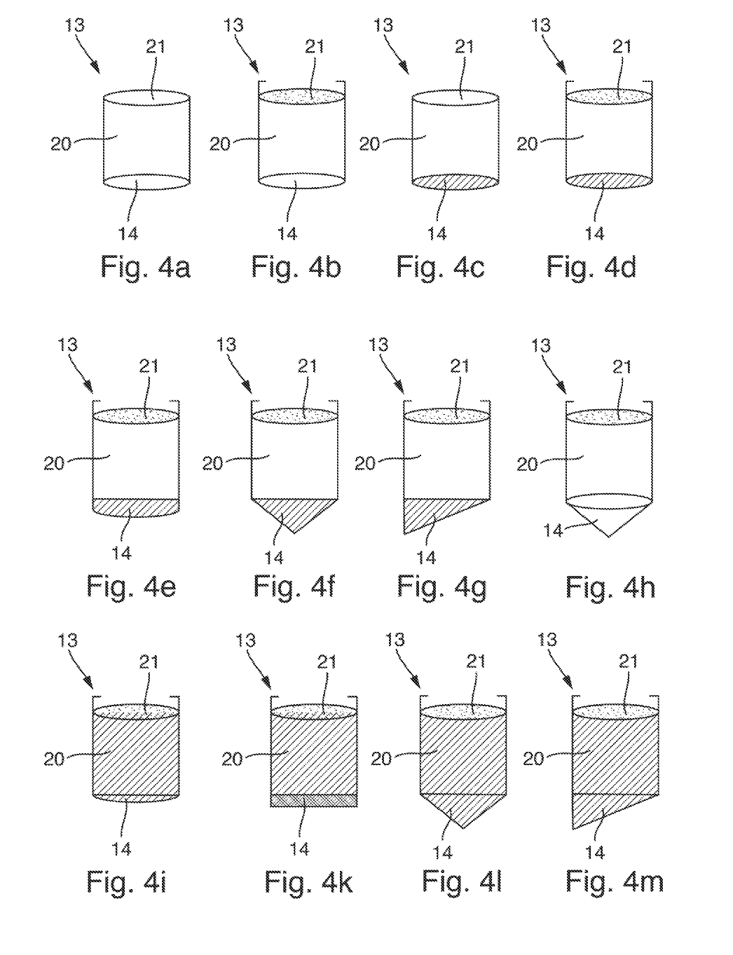

An additional embodiment of the present disclosure includes that the protective device 13 comprise multiple functional layers. Shown in FIGS. 4a-4m by way of example are various preferred variants of a protective device 13 which, in addition to a first functional layer 14 facing towards the medium 4, moreover has: a second layer 20 which, for example, may contain a filler material (in particular, in the form of inorganic fibers), a gel, the diffusion-inhibiting component 18, or also the protective substance 16; and a second functional layer 21 which faces towards the sensor unit 3. The first functional layer 14 and second functional layer 21 may thereby be of identical or different designs.

The functional layers 14 and 21, as well as the layer 20, may be designed to be both media-permeable, for example gas-permeable or fluid-permeable, or media-impermeable. However, in every case, it is permeable to the analyte. This is illustrated by way of example using FIGS. 4a-4d. In FIG. 4a, both functional layers 14 and 21 are designed to be media-permeable; in FIG. 4b, the second functional layer 21 is media-impermeable; in FIG. 4c, the first functional layer 14 is media-impermeable; and, finally, in FIG. 4d, both functional layers 14 and 21 are designed to be media-impermeable.

Furthermore, the first functional layer 14 may have a bubble-repelling geometry, as illustrated by way of example for various variants using FIGS. 4e-4m. Furthermore, in FIG. 4k, the first functional layer is designed such that it is impermeable to a medium 4 in the form of a gas.

In the following, various variants for protective devices 13 are indicated by way of example, corresponding to one of the embodiments from FIGS. 3a-3d or FIGS. 4a-4m.

Variant 1:

The functional layers 14 and 21 are designed to be media-permeable, and the layer 20 contains inorganic fiber bundles, e.g., polyaluminosilicates or polysilicic acids, which exhibit strong capillary forces, as well as a protective substance 16 in the form of a water-insoluble buffer substance, which ensures a pH buffering with approximately pH 7-pH 10. The first functional layer 14 is, for example, designed to be tapered in form by means of single pore, or in the form of a hydrophilic, and thus water-absorbing, membrane. For example, cross-linked polyvinyl alcohols or a superhydrophilic porous PVDF are to be considered in this regard.

Variant 2:

In an embodiment similar to variant 1, activated charcoal as an adsorbent is used as a protective substance 16, which is contained in the layer 20. The activated charcoals may be further oxidized for a better wetting capability. Alternatively, zeolites, MOF, ZIF, or polyimides may also be added as adsorbents.

Variant 3:

The layer 20 contains fiber bundles to which metal oxides are added as a protective substance 16.

Variant 4:

A basic buffer, e.g., a carbonate buffer, or a natural substance such as an exine and/or microporous glass, is used as a protective substance 16. With regard to the use of natural substances to encapsulate a luminescent dye, plant spores or fungal spores may be used, e.g., Lycopodium clavatum, from which may, in particular, be extracted labile, fluorescent materials, for example, proteins, lipids, nucleic acids, or carbohydrates.

One possibility for production includes suspending Lycopodium clavatum spores (250 g) in acetone and boiling under reflux for approximately 4 hours. The dispersion is then centrifuged, and the excess decanted. Following this, the defatted spores are stirred overnight under reflux in 4% potassium hydroxide solution (vol %); filtered; neutrally washed with hot water; and then washed with ethanol until colorless. The base hydrolyzed sporopollenins are then dried overnight in a desiccator on phosphorus pentoxide. 150 g of the product so obtained is subsequently suspended in orthophosphate (85%, 600 ml) and stirred for one week under reflux. The degreased and base-hydrolyzed and acid-hydrolyzed sporopollenins (exines) are finally filtered, neutrally washed with water, and washed and refluxed again for 1 h with hydrochloric acid (200 ml), acetone (200 ml), and ethanol, filtered, and, at the end, dried with phosphorus pentoxide in a desiccator.

Variant 5:

For applications which are sensitive to carbon dioxide (i.e., high cross-sensitivity), a 0.01 N potassium hydroxide solution may be added to the layer 20.

Variant 6:

The protective device 13 has a first functional layer 14 in the form of a membrane, which has a pH buffer polymer and/or a redox buffer polymer and/or an absorbent and/or a reducing agent and/or a catalyst and/or a polymer.

Variant 7:

Finely-dispersed platinum, which, for example, is deposited onto a surface of a microporous glass of the first functional layer 14, serves as a protective substance 16. The finely-dispersed platinum has a strong hydrophilic effect and, for this, is in a position to take up water, even in the dry state, via strong capillary action.

Variant 8:

In this variant, the protective device 13 comprises a first functional layer 14 made of an elastic material permeable to the analyte, e.g., a thin silicone sleeve, which is sealed against the environment at one end. Contained in a region facing towards the sealed side is a protective layer 17 with a protective substance 16 in the form of a basic pH buffer gel with activated charcoal. Such a protective device 13 of elastic design has the advantage that the protective device 13 may first be filled with water and, subsequently, may be attached to the sensor unit 3, for example, be pulled over the sensor cap 2. The elastic material, advantageously, has a comparatively high tear strength and may be folded around the sensor cap 2 in a region of said sensor cap 2 that is applied towards the medium 4, and, in this way, may be installed on the sensor 1. However, in this regard, numerous additional installation possibilities are conceivable, depending upon the embodiment of the sensor 1, which installation possibilities likewise fall under the present disclosure.

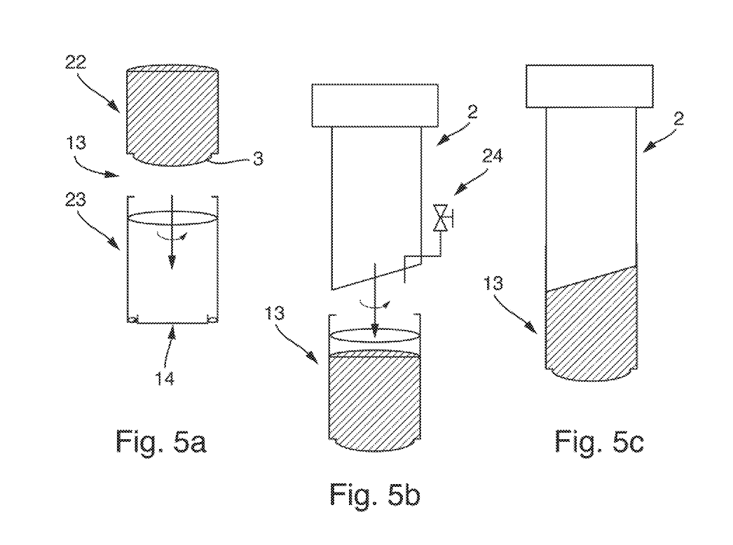

An additional possible embodiment of the protective device according to the present disclosure is illustrated in FIGS. 5a-5c. The protective substance 16 is arranged, for example as part of an aqueous solution, in an inlay 22 which can be introduced into a cap 23. The cap 22 thereby comprises at least the first functional layer 14 which, in the present instance, is designed in the form of a membrane. The inlay 22 is introduced, involving, for example, a rotational motion, into the cap 23, as illustrated in FIG. 5a. The protective device 13 is subsequently attached, likewise involving, for example, a rotational motion, to the sensor cap 2 as illustrated in FIG. 5b. Via the attachment to the sensor cap 2, the inlay 22 is destroyed such that the protective substance 16, or the aqueous solution, remains in the cap 23. Finally, the sensor cap 2 with protective device 13 attached thereon is shown in FIG. 5c. Via the use of an inlay 22, the protective device 13 can, advantageously, be attached to the sensor unit 3 or to the sensor cap 2, without admission of gas.

The sensor cap 2 may, optionally, also has a valve 24 for discharging gases remaining in the inner space of the cap 23 upon installation. Such a valve 24 may also, alternatively, be part of the protective device 13. It is further noted that, in addition to the protective substance 16, the inlay 22 may also contain a diffusion-inhibiting component 18, as well as additional optional components.

Comparison tests of optochemical sensors 1, with and without protective device 13 according to the present disclosure, show that the protective device 13 leads to a significant increase in the mechanical stability, in the case of after long-term stressing in 5% sodium hypochlorite solution. Conventional sensor units 102 often showed cracks and stark indications of aging at transition points to the O-ring 10 after 14 days stirring in 90° C. sodium hydroxide solution. With additional mechanical loading such as mechanical wear, cracks in the membrane 11, once produced, lead, in the extreme case, to the sensor spot tearing off due to particles floating past. In a less extreme case, cracks in the membrane 11 may lead to measurement value errors, due to delayed adjustment of the partial pressures. Voids between membrane 11 and substrate 7 also lead to what are known as carry-over effects and measurement value errors, for example, due to excessive prevailing partial pressures, e.g., within the sensor unit 3. In principle, the measurement values were more stable when using a protective device 13.

In addition to this, it has, surprisingly, been shown that a lower change in measurement value of the partial pressures could be achieved after 1 day of treatment in 70° C., 3% sodium hypochlorite solution, in particular, at low partial pressures. In particular, for measurement values in a range between 0 hPa and 25 hPa, partial pressure increases due to appearance of degradation at the dye were determined by radical-generating cleaning agents.

Claimed is:

1. A protective device for a sensor unit of an optochemical sensor for determining or monitoring at least one analyte present in a medium, the protective device comprising:
at least one protective substance for protecting the sensor unit against a physical and/or chemical alteration caused by at least one substance contained in the medium; and
an at least partially media-permeable functional layer,
wherein the protective device, in a region facing towards the medium, is embodied to be attached to the sensor unit or applied to the sensor unit.

2. The protective device of claim 1, wherein the at least one protective substance is:
a buffer, including a pH buffer polymer, a pH buffer solution, a redox buffer, and/or a redox buffer polymer;
an adsorbent;
a radical scavenger;
a reducing agent;
a catalyst; or
a polymer.

3. The protective device of claim 2, wherein the polymer of the at least one protective substance is an acrylamide or an acrylamide with at least one imidazole unit.

4. The protective device of claim 1, wherein the functional layer is embodied:
in the form of a diaphragm, including a ceramic diaphragm, a fiber diaphragm or a ground diaphragm;
in the form of an annular gap;
in the form of an organic or inorganic membrane;
in the form of a gel; or
in the form of a dispersion.

5. The protective device of claim 1, wherein the protective device is embodied in the form of a cap or capsule releasably connectable with the sensor unit.

6. The protective device of claim 1, further comprising a releasable attachment unit structured to enable attachment of the protective device to the sensor unit. The protective device of claim 1, wherein:
the protective substance is included in the functional layer;
the protective substance is contained in a protective layer attached to the functional layer on a side opposite the medium; or
the protective substance is part of an aqueous solution that is at least partially surrounded by the functional layer.

8. The protective device of claim 1, wherein:
the protective device is embodied to be fastened to the sensor unit such that a region of the protective device adjacent the medium, and/or a transition region between the protective device and the sensor unit, is substantially gapless and/or without clearance; and/or
a surface of the protective device adjacent the medium has a surface region shaped to optimize flow.

9. The protective device of claim 1, comprising a first functional layer and a second functional layer, wherein at least the protective substance is located between the first functional layer and the second functional layer.

10. The protective device of claim 9, wherein the first functional layer or the second functional layer includes inorganic fibers adapted to absorb liquid.

11. The protective device of claim 1, wherein at least the protective substance is present in an inlay which is at least partially surrounded by the functional layer.

12. The protective device of claim 1, further comprising at least one analyte-permeable, diffusion-inhibiting component.

13. The protective device of claim 12, wherein the diffusion-inhibiting component is contained in a diffusion barrier layer disposed on a side of the protective device adjacent the sensor unit.

14. The protective device of claim 1, further comprising at least one indicator component formulated to signal replacement of the protective device.

15. The protective device of claim 1, further comprising a substance for reducing a surface tension of at least one component of the protective device, wherein the substance is an alcohol or surfactant.

16. An optochemical sensor for determining and/or monitoring at least one analyte present in a process medium, the senor comprising:
a sensor unit including a substrate to which an indicator is applied;
a protective device attached to the sensor unit, the protective device including:
at least one protective substance for protecting the sensor unit against a physical and/or chemical alteration caused by at least one substance contained in the medium; and
an at least partially media-permeable functional layer, wherein the protective device, in a region facing towards the medium, is embodied to be attached to the sensor unit or applied to the sensor unit;
a light source adapted to transmit measuring radiation, thereby exciting the indicator to emit luminescence radiation;
a detection unit adapted to detect the correspondingly generated luminescence radiation; and
an electronics unit configured to determine the concentration or the partial pressure of the at least one analyte in the process medium based on a quenching of the luminescence radiation of the indicator.

17. The optochemical sensor of claim 16, wherein the at least one protective substance is:
a buffer, including a pH buffer polymer, a pH buffer solution, a redox buffer, and/or a redox buffer polymer;
an adsorbent;
a radical scavenger;
a reducing agent;
a catalyst; or
a polymer.

18. The optochemical sensor of claim 16, wherein the functional layer is embodied:
in the form of a diaphragm, including a ceramic diaphragm, a fiber diaphragm or a ground diaphragm;
in the form of an annular gap;
in the form of an organic or inorganic membrane;
in the form of a gel; or
in the form of a dispersion.

19. The optochemical sensor of claim 16, wherein the protective device is embodied in the form of a cap or capsule releasably connectable with the sensor unit.

20. The optochemical sensor of claim 16, wherein:
the protective substance is included in the functional layer;
the protective substance is contained in a protective layer attached to the functional layer on a side opposite the medium; or
the protective substance is part of an aqueous solution that is at least partially surrounded by the functional layer.
